(19) United States
(12) Patent Application Publication
(10) Pub. No.: US 2007/0204764 A1
(43) Pub. Date: Sep. 6, 2007

(54) COMPOUNDS AND METHODS FOR REDUCING WATER CONTENT IN CEMENTITIOUS MIXTURES

(76) Inventors: Jianhua Mao, West Chester, OH (US); James H. Irvine, Cincinnati, OH (US)

Correspondence Address: COGNIS CORPORATION;PATENT DEPARTMENT, 300 BROOKSIDE AVENUE, AMBLER, PA, 19002, US

(21) Appl. No.: 11/625,375

(22) Filed: Jan. 22, 2007

Related U.S. Application Data
(60) Provisional application No. 60/761,200, filed on Jan. 23, 2006.

(51) Int. Cl. C04B 18/06; C04B 24/00; C04B 40/00

(52) U.S. Cl. 106/708; 106/823; 106/724; 536/4.1; 554/103

(57) ABSTRACT

Compounds for reducing water content in cementitious mixtures selected from an amphoteric, an alkyl polyglycoside, an ester, a triglyceride derivative, and mixtures thereof are provided. Methods are also provided for reducing water content in cementitious mixtures.

### CROSS-REFERENCE TO RELATED APPLICATIONS

This application claims priority under 35 U.S.C. § 120 from U.S. Provisional Application No. 60/761,200, filed on Jan. 23, 2006, the entire disclosure of which is hereby incorporated by reference.

### FIELD OF THE INVENTION

The invention relates generally to concrete additives, and more particularly, to compounds and methods for reducing water content in cementitious mixtures.

### BACKGROUND INFORMATION

There is a growing demand for concrete in building and construction applications, which requires increased volumes of Portland cement, which is costly. Cement may be combined with up to 25 percent by weight of water to which aggregate is added to make concrete.

The demands of industry require that concrete be of sufficient strength and durability. In general, cement products have higher physical strength as the amount of water added remains low. Generally, although an increase in the amount of water improves workability, compressive strength is decreased, and cracking may occur. The addition of up to 25 percent of water to form the cement may also produce products having low flexural strength. To increase flexural strength, fibers may be added to the products.

The flowability (also known as “slump”) of cementitious compositions may be increased by the addition of various additives, without increasing the amount of water content of the initially-formed composition. The additives, or “admixtures” are termed “water reducers” or “superplasticizers” when used for this purpose. Lignin-sulfonate is an example of a water reducer. Another example of a water reducer is a polycarboxylic acid dispersant.

Cement may also contain an air-entraining agent to improve properties, including workability and fluidity of a cement composition, although the water content in the composition may be reduced.

A need remains for a compound and method for reducing water content in cement for use in cementitious compositions.

### SUMMARY OF THE INVENTION

Briefly described, in one aspect of the invention, a compound for reducing water content in cementitious mixtures is selected from an amphoteric, an alkyl polyglycoside, an ester, a triglyceride derivative, and mixtures thereof.

In another aspect of the invention, a method for reducing water content in a cementitious mixture includes adding to Portland cement a compound selected from an amphoteric, an alkyl polyglycoside, an ester, a derivative of triglyceride, and mixtures thereof.

### DETAILED DESCRIPTION OF THE INVENTION

According to an aspect of the invention, a compound for reducing water content in a cementitious mixture is selected from the group consisting of: an amphoteric, an alkyl polyglycoside, an ester, a triglyceride derivative, and mixtures thereof. The compound may be amphoteric. The amphoteric compound may be a betaine. The betaine may be cocoamide propyl betaine. The compound may be an alkyl polglycoside. The alkyl polyglycoside may be a C₈-C₁₈ alkyl polglycoside or a C₈-C₁₂ alkyl polglycoside. The compound may be an ester. The ester may be a triglyceride. The triglyceride may contain alkyl chains with 14-18 carbon atoms. The triglyceride may be an oil selected from rapeseed oil, soybean oil, coconut oil, tall oils, and mixtures thereof. The compound may be a triglyceride derivative. The triglyceride derivative may be an alkoxylated triglyceride. The triglyceride derivative may be an ethoxylated triglyceride. The compound may be incorporated into a concrete structure.

According to another aspect of the invention, a method for reducing water content in a cementitious mixture includes adding to Portland cement a compound selected from an amphoteric, an alkyl polyglycoside, an ester, a derivative of triglyceride, and mixtures thereof. The method may further include the step of treating off-grade fly ash with the compound. The method may further include the step of adding the treated fly ash in an amount of up to 25 percent by weight of the total amount of cement. A concrete structure may be formed according to the above-described methods.

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “or” refers to an inclusive “or” and not to an exclusive “of”. For example, a condition A or B is satisfied by any one of the following. A is true (or present) and B is false (or not present); A is false (or not present) and B is true (or present); and both A and B are true (or present).

The terms “a” or “an” as used herein are to describe elements and components of the invention. This is done merely for convenience and to give a general sense of the invention. The description herein should be read to include one or at least one and the singular also includes the plural unless indicated to the contrary.

Advantageously, the use of a compound according to an aspect of the invention reduces water content (by percentage of the concrete mixture) while increasing the strength of the resulting concrete. The reduction in water needed to achieve the same strength specifications advantageously results in a cost-saving. Suitable compounds are described below.

A suitable amphoteric compound includes, but is not limited to, DEHYTON K. DEHYTON K is a cocoamide propyl betaine and is available from Cognis Deutschland in Germany. Other suitable amphoteric compounds may also be used, including but not limited to N-alkyl-N,N-dimethyl ammonium glycinates, for example cocoalkyl dimethyl ammonium glycinate, N-acylaminopropyl-N,N-dimethyl ammonium glycinates, for example coco-acylaminopropyl dimethyl ammonium glycinate, and 2-alkyl-3-carboxymethyl-3-hydroxyethyl imidazolines containing 8 to 18 carbon atoms in the allyl or acyl group and cocoacyl-aminoethyl hydroxyethyl carboxymethyl glycinate, such as DEHYTON AB 30 coco betaine (CAS#68424-94-2).

A suitable alkyl polyglycoside includes, but is not limited to, AGNIQUE PG 8107. AGNIQUE PC 8107 is a C₈-C₁₀ alkyl polyglucoside, with a degree of polymerization (D.P.) of 1.7 and is available from Cognis Deutschland in Germany or Cognis Corporation in the U.S. Other suitable alkyl polyglycosides may also be used to treat fly ash, including AGNIQUE PG 8105, a C₈-C₁₀ alkyl polyglucoside, with a degree of polymerization (D.P.) of 1.5, AGNIQUE 9116, which is a C₉-C₁₁ alkylpolyglucoside with DP=1.6, AGNIQUE PG 264, a C₁₂-C₁₆ alkylpolyglucoside with DP=1.4, all of which are available from Cognis Deutschland, Germany or Cognis Corporation in the U.S.

A suitable ester includes, but is not limited to, Cognis-34072. Cognis-34072 is a triglyceride, which could be from natural or synthetic sources. The alkyl chain in the triglyceride may contain from C₄-C₂₂ carbon atoms, and may be saturated or unsaturated, branched or linear, and may also contain aromatic component. Suitable triglycerides may also be vegetable oils, including, but not limited to, rapeseed oil, soybean oil, coconut oil, tall oils, and mixtures thereof. Other suitable esters include, but are not limited to, esters of monohydric and polyhydric alcohols with linear or branched fatty acids, and mixtures thereof. Fatty acids include, but are not limited to, linear and branched fatty acids with from C₄₋₂₂ carbons in the alkyl chain, and mixtures thereof. Monohydric alcohols include, but are not limited to, methanol, ethanol, butanol, propanol, isopropanol, isobutanol, tert-butanol, and mixtures thereof. Polyhdric alcohols include, but are not limited to, ethylene glycol, diethylene glycol, trithylene glycol, 1,2propylene glycol, 1,3propylene glycol, 1,4butylene glycol, glycerol, polyoxyethylene glycols, polyoxy-propylene glycols, sorbitol, and mixtures thereof. Esters of polyhydric alcohols include, but are not limited to, complete and partial esters. A partial ester of a polyhydric alcohol includes, but is not limited to, glycerol monooleate, glycerol dioleate, glycerol mono-stearate, glycerol monoisostearate, and mixtures thereof.

A suitable triglyceride derivative includes, but is not limited to, an alkoxylated triglyceride, including an ethoxylated triglyceride. The degree of alkoxylation is in the range of 0-200 moles of at least one alkylene oxide selected from the group consisting of ethylene oxide, propylene oxide, butylene oxide, and combinations thereof per mole of triglyceride. Suitable ethoxylated triglycerides include, but are not limited to, AGNIQUE SBO-5, AGNIQUE SBO-10, AGNIQUE SBO-20, AGNIQUE CSO-16, AGNIQUE CSO-25, AGNIQUE RSO-5, AGNIQUE RSO-10 and AGNIQUE RSO-30.

A suitable fatty alcohol includes, but is not limited to, a fatty alcohol with an alkyl chain containing from 6-22 carbons or mixtures thereof. The alkyl chain may be either linear or branched or mixtures thereof. A suitable fatty alcohol includes a C₈ alcohol, LOROL C8-98, from Cognis Corporation, a C₈₋₁₀ alcohol, LOROL C8-10SPV from Cognis Corporation, or a C₁₂₋₁₄ fatty alcohol, LOROL C12-14A from Cognis Corporation, or isostearyl alcohol.

A suitable alkoxylated fatty alcohol includes, but is not limited to, fatty alcohols with alkyl chains containing from 6-22 carbons or mixtures thereof. The fatty alcohol may be alkoxylated with from 0-200 moles of at least one alkylene oxide selected from the group consisting of ethylene oxide, propylene oxide, butylene oxide, and combinations thereof per mole of alcohol. For example, a suitable alkoxylated fatty alcohol may contain an average of about 5 moles of ethoxylate per mole of alcohol. Alternatively, a suitable alkoxylated fatty alcohol includes, but is not limited to, a C₆₋₁₂ alcohol with on average 5 moles of ethylene oxide and a C₁₆₋₁₈ fatty alcohol with, on average, 5 moles of ethylene oxide.

A suitable alkoxylated polyhydric fatty alcohol includes, but is not limited to, ethylene glycol, diethylene glycol, triethylene glycol, 1,2-propylene glycol, polyoxypropylene glycols, 1,3-propylene glycol, 1,4-butylene glycol, pentane-1,5-diol, hexane-1,6-diol, hexane-1,2,6-triol, glycerol and bis-(4-hydroxycyclohexyl)-2,2-propane. The polyhydric alcohol may be, but is not limited to, dihydric, trihydric, tetrahydric and pentahydric alcohols.

The polyhydric alcohol may be alkoxylated with 0-200 moles of at least one alkylene oxide selected from the group consisting of ethylene oxide, propylene oxide, butylene oxide, and combinations thereof per mole of alcohol. For example, a suitable alkoxylated polyhydric alcohol may contain an average of about 15 moles of ethoxylate and about 60 moles of propoxylate per mole of alcohol. It should be understood that when an alcohol is alkoxylated and includes at least 5 moles of EO, a distribution of ethoxylates will be present, ranging from 0 moles of EO, an average of 5 moles of EO and up to 10-14 moles of EO.

The compound may be used individually or in mixtures. In one embodiment, a mixture of an alkyl polyglucoside and an amphoteric is provided in a ratio of 0.1% to 0.5%, and also in a ratio of 0.1% to 1.0%.

A suitable fly ash to Portland cement ratio for use according to an aspect of the invention is 5:95 to 25:75 Other suitable ratios include 20:80 and also 15:85. It should be understood that currently under most Department of Transportation (DOT) regulations in many states, the replacement of cement is limited to a maximum of 20:80. Although the ratio of 20:80 is not presently exceeded, it is possible that it may be extended in the future, depending of course upon the individual states' DOT regulations. Therefore, the upper maximum fly ash replacement according to an aspect of the invention would suitably be 40:60.

Unless otherwise defined, all technical and scientific terms used herein have the same meaning as commonly understood by one of ordinary skill in the art to which the invention belongs. Although methods and materials similar or equivalent to those described herein can be used in the practice or testing of the invention, suitable methods and materials are described below. All publications, patent applications, patents and other references mentioned herein are incorporated by reference in their entirety. In case of conflict, the present specification, including definitions, will control. In addition, the materials, methods and examples are illustrative only and are not intended to be limiting.

### EXAMPLES

In the following Examples, concrete mixtures were prepared using conventional industry procedures. It is to be understood that the concrete mixture may be made in any suitable mixing device or by manual mixing. It is to be understood that although the term “Portland cement” is used in the Examples, other types of cement may also be suitable. Although fly ash was used in the following examples, it is also to be understood that the water-reducing agent may be suitably used in a concrete mixture which does not contain fly ash. The off-grade fly ash used in the Examples is available from Beckjord Generating Station, a power plant in New Richmond, Ohio.

The fly ash was treated as follows: Untreated fly ash was mixed with a compound at a ratio of 0.1 oz. to 2.0 oz. per 20 lbs. fly ash in an inline mixer device at a temperature ranging between 15-100° C. In the Examples, the temperature range was between 30-75° C. It is to be understood that the mixing devices and methods used can vary and are not limited to the devices and methods described herein, as a skilled artisan will appreciate. Regardless of the device and method used, the compound should be distributed evenly into the fly ash. Alternatively, the compound may be added subsequently to the concrete mixture described above that includes untreated fly ash. The compound may also be used during the mixing step for preparing a concrete mixture. The compound achieves the same results in a concrete mixture that does not contain fly ash.

### Example 1

In Example 1, 18.9 lbs. of Portland cement, 3.3 lbs. off-grade fly ash (Beckjord, LOI 4.89%) treated with Cognis 34072 at a rate of 0.24 oz./20 lb. of fly ash, 48.1 lbs. sand, 59.3 lbs. gravel, and about 7.9 lbs. of water were mixed in a concrete mixer.

### Comparative Example 1

In Comparative Example 1, 18.9 lbs. of Portland cement, 3.3 lbs. off-grade fly ash (Beckjord, same as in Example 1 but untreated), 48.1 lbs. sand, 59.3 lbs. gravel, and about 9.5 lbs. of water were mixed in a concrete mixer.

Results

After the concrete mixtures were prepared for Example 1 and Comparative Example 1, slump was measured according to ASTM C-143. Slump in Example 1 was 4.5″ and in Comparative Example 1 was 4″.

The fly ash used in Example 1 and Comparative Example 1 was off-grade fly ash. When the off-grade fly ash was treated with Cognis 34072 at a rate of 0.24 oz./20 lb. of fly ash as in Example 1, the mixture required only 7.9 lbs. water.

### Example 2

The procedure for Example 1 was followed, except a different off-grade fly ash was used, and was treated with DEHYTON K at a rate of 0.5 oz./20 lb. fly ash.

### Comparative Example 2

The procedure for Comparative Example 1 was followed, except a different off-grade fly ash was used.

Results

Example 2 only required 8.1 lbs. of water, whereas Comparative Example 2 required 9.5 lbs. water. Slump was measured as in Example 1. The slump in Example 2 was measured at 3.5″, whereas in Comparative Example 2, slump was only 3″.

The invention has been described with reference to specific embodiments. One of ordinary skill in the art, however, appreciates that various modifications and changes can be made without departing from the scope of the invention as set forth in the claims. For example, alkoxylated triglycerides and alkoxylated fatty acids are described as useful for treating fly ash. In addition, a suitable alkoxylated fatty acid useful according to an aspect of the invention ash include, but is not limited to, AGNIQUE FAC 181-6 (6 mole ethoxylated oleic acid).

While the examples used off-grade fly ash, other grades of fly ash may be suitable for treating according to the invention. Accordingly, the specification is to be regarded in an illustrative manner, rather than a restrictive view and all such modifications are intended to be included within the scope of the invention.

Benefits, other advantages, and solutions to problems have been described above with regard to specific embodiments. The benefits, advantages, solutions to problems and any element(s) that may cause any benefit, advantage, or solution to occur or become more pronounced are not to be construed as a critical, required, or essential feature or element of any or all of the claims.

What is claimed is:

1. A compound for reducing water content in cementitious mixtures, selected from the group consisting of: an amphoteric, an alkyl polyglycoside, an ester, a triglyceride derivative, and mixtures thereof.

2. The compound according to claim 1, wherein the compound is amphoteric.

3. The compound according to claim 2, wherein the amphoteric compound is a betaine.

4. The compound according to claim 3, wherein the betaine is cocoamide propyl betaine.

5. The compound according to claim 1, wherein the compound is an alkyl polglycoside.

6. The compound according to claim 5, wherein the alkyl polyglycoside is a C₈-C₁₈ alkyl polglycoside.

7. The compound according to claim 5, wherein the alkyl polglycoside is a C₈-C₁₂ alkyl polglycoside.

8. The compound according to claim 1, wherein the compound is an ester.

9. The compound according to claim 8, wherein the ester is a triglyceride.

10. The compound according to claim 9, wherein the triglyceride contains alkyl chains with 14-18 carbon atoms.

11. The compound according to claim 9, wherein the triglyceride is an oil selected from the group consisting of rapeseed oil, soybean oil, coconut oil, tall oils, and mixtures thereof.

12. The compound according to claim 1, wherein the compound is a triglyceride derivative.

13. The compound according to claim 12, wherein the triglyceride derivative is an alkoxylated triglyceride.

14. The compound according to claim 13, wherein the alkoxylated derivative is an ethoxylated triglyceride.

15. A method for reducing water content in a cementitious mixture, comprising the step of:
adding to Portland cement a compound selected from the group consisting of an amphoteric, an alkyl polyglycoside, an ester, a derivative of triglyceride, and mixtures thereof.

16. The method according to claim 15, further comprising the step of treating off-grade fly ash with the compound.

17. The method according to claim 16, further comprising the step of adding the treated fly ash in an amount of up to 25 percent by weight of the total amount of cement.

18. The compound according to claim 1, incorporated into a concrete structure.

19. A concrete structure formed according to the method of claim 15.

20. A concrete structure formed according to the method of claim 17.
